(19) United States
(12) Patent Application Publication
(10) Pub. No.: US 2012/0217208 A1
(43) Pub. Date: Aug. 30, 2012

(54) INTERCHANGEABLE MULTI-LEVEL RETAIL DISPLAY AND METHOD THEREOF

(76) Inventors: E. Alain Levi, Los Angeles, CA (US); Thomas Reistetter, Los Angeles, CA (US)

(21) Appl. No.: 13/035,864

(22) Filed: Feb. 25, 2011

(51) Int. Cl. A47F 7/02; E05B 73/00; B23P 11/00; A47F 1/04

(52) U.S. Cl. 211/4; 211/59.2; 211/85.2; 29/428

(57) ABSTRACT

The present invention is directed to a retail display having a surface with different elevations. The surface can further be divided into quadrants. A plurality of posts can be mounted in various positions on the different elevations of the top of the surface. The posts can be different heights and have merchandising display holders attached to display a variety of items. Both the posts and the merchandising display holders can be configured in different manners to achieve different themed display zones for each quadrant. The configuration of different elevations provide for improved viewing of items on display and a more aesthetically pleasing display of items.

### BACKGROUND OF THE INVENTION

1. Field of the Invention

This invention relates to an interchangeable multi-level retail display and, more particularly, to a method and apparatus for the display of merchandise items having interchangeable arrangements and configurations on a multi-elevational display.

2. Background of Related Art

The use of conventional display stands to exhibit jewelry is known in the art. For example, U.S. Pat. No. 6,991,143 to Gillis is directed to a vertical frame member inserted into a pedestal having a hollow post with an opening for receiving the vertical frame member. This type of construction exemplifies the kinds of stand assemblies in the art, in which the stand is easily susceptible to be detached from the pedestal. Such assemblies are known to be unstable and unsafe because they can topple over easily when jewelry is removed from the stand by a consumer. Instability is one disadvantage of conventional display stands known in the art.

There are several other disadvantages in using conventional display stands known in the art. Another disadvantage is that the conventional display stand only exhibits one type of jewelry. The display does not allow for a comprehensive exhibit of the merchandise. There is a need to present consumers with a greater number of choices in a display at one time.

Those of ordinary skill in the art have utilized trays to display jewelry to attempt to overcome the instability and limited display of conventional display stands. These trays are little more than container bins, lacking any specific display components to feature the different and particularized accessory items. The stands or trays are spread in a disorganized or uniform manner across counters.

Such conventional display stands, racks and trays in the art lack the capacity for variation in arrangement and configuration. Because jewelry stands generally feature only one type of jewelry per stand, a number of different stands are required to exhibit a number of different kinds of jewelry. To arrange and rearrange a conventional display, it is necessary to move each entire stand. For displays featuring a multitude of stands, the task of arrangement and rearrangement is all the more inefficient and inconvenient. In short, there is no unified display in which a plurality of stands can be easily and efficiently arranged and configured as necessary accommodate different presentations.

Further, conventional display stands and trays do not stand out to the consumer but blend in as average, known marketing tools. They do not effectively promote the jewelry as intended. There is no depth to the display to attract consumers.

Therefore, what is needed in the art is an improved marketing tool. More particularly, there is a need to create a more aesthetically pleasing display that will draw in consumers for greater sales of the items on display. For example, there is a need to present the items in a three-dimensional manner, with greater depth to the display, to peak the interest of the consumers and attract the consumers to the display. There is also a need to present multiple, stable displays in one system to present jewelry or other items in an organized and visually stimulating manner. A multi-dimensional, multi-component display can provide a clear and organized view of the marketed items compared to those displays known in the art.

With these goals in mind, the inventors created an improved marketing tool that is a multi-elevational, interchangeable retail display that is capable of being easily and efficiently rearranged to create appealing configurations and attract consumers to the items on display.

### SUMMARY OF THE INVENTION

It is therefore an object of the present invention to provide a confined, multi-level and interchangeable retail display in which a variety of items may be marketed in a clear, organized, and aesthetically pleasing manner to better attract consumers.

It is therefore an object of the present invention to provide a multi-level interchangeable retail display in which various display items can be easily coordinated in different assembled arrangements and configurations.

It is therefore an object of the present invention to provide a multi-level interchangeable retail display that is stable and safe, yet easy and efficient to disassemble for arrangement.

A display according to the present invention comprises a surface having at least two elevations. Each post can be attached at one end to the surface and another end of the post can receive a merchandising display holder such that a variety of items, such as different types of jewelry, can be displayed.

Another embodiment of the display comprises a table having a top formed in any shape, where the top has four approximately equal quadrants. For example, the top can be in the shape of an ellipse, circle, square, rectangle, or other geometric shape. The first and second quadrant can have an approximately equal first elevation and diagonally oppose each other. The third and fourth quadrant can have an approximately equal second elevation different from the first elevation and diagonally oppose each other.

Each quadrant can have at least one receptacle formed therein for receiving at least one post. Each post can have a first end and a second end and have more than one length among them. The first end of the post is capable of stable insertion into at least one of the receptacles and the second end is capable of receiving a merchandising display holder. The receptacles and first ends of the posts can further comprise threaded portions to engage one another. The posts are capable of being interchangeable among the receptacles and the merchandising display holders are capable of being interchangeable among the posts.

The merchandising display holder can fit within an inner diameter of the second end of the post. Further, each of the second ends of the posts can have a locking member capable of locking each of merchandising display holder such that each the merchandising display holder is capable of being securely attached to each post. The display can thereby display items, such as a variety of types of jewelry or signs.

A method of assembly of a multi-level, interchangeable retail display is also described.

### BRIEF DESCRIPTION OF THE DRAWINGS

FIG. 1 is a front orthogonal view of an embodiment of a display in accordance with the present invention.

FIG. 2 is a top orthogonal view of an embodiment of a display in accordance with the present invention.

FIG. 3 is a side orthogonal view of an embodiment of a display in accordance with the present invention.

FIG. 4 is a perspective view of an embodiment of a display in accordance with the present invention.

FIG. 5 is a front orthogonal and partial transparent view of an embodiment of a post and a front orthogonal view of an embodiment of a merchandising display holder in accordance with the present invention.

FIG. 6 is a front orthogonal view of an embodiment of a merchandising display holder in accordance with the present invention.

FIG. 7 is a front orthogonal view of an embodiment of a merchandising display holder in accordance with the present invention.

FIG. 8 is a front orthogonal view of an embodiment of a merchandising display holder in accordance with the present invention.

FIG. 9 is a perspective view of an embodiment of a display surface or top in accordance with the present invention.

### DETAILED DESCRIPTION OF THE INVENTION

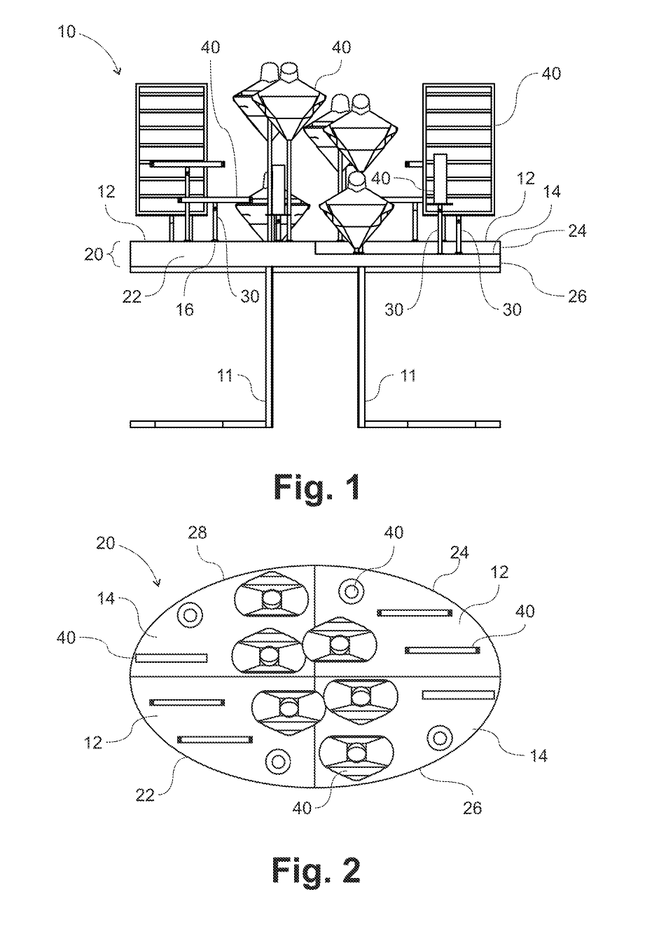

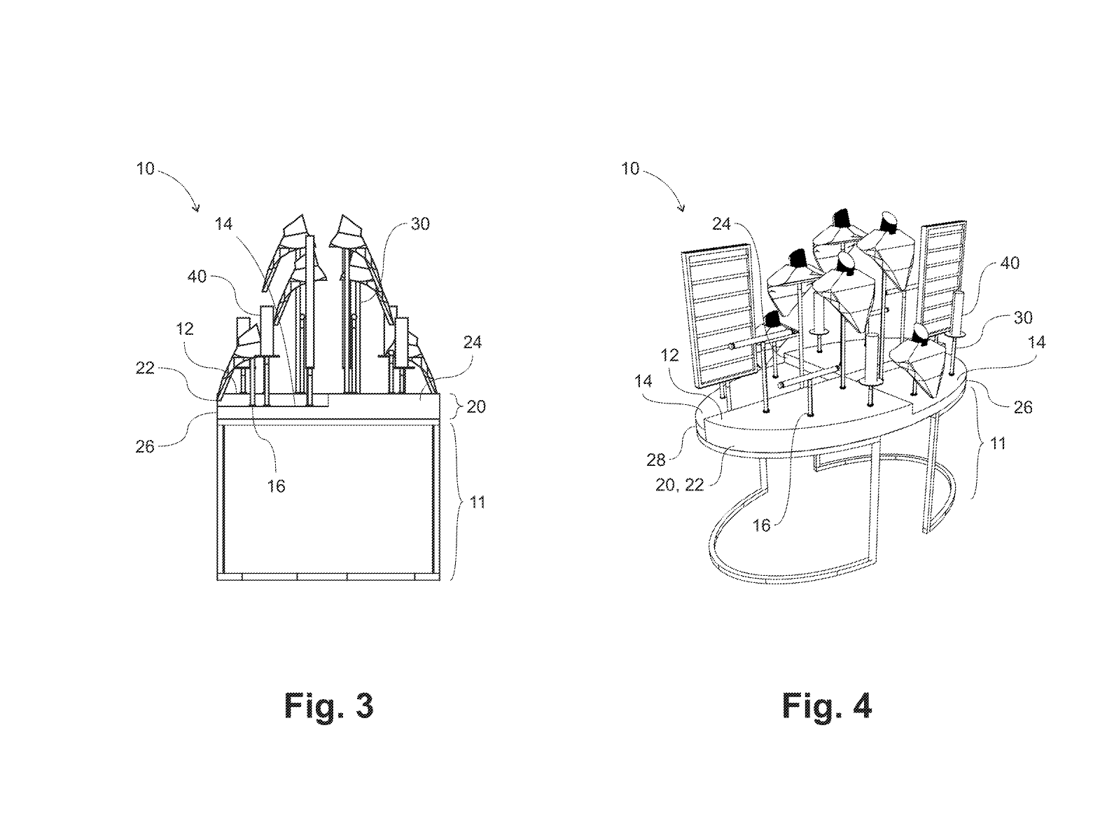

FIGS. 1-4 and 9 show an embodiment of multi-level interchangeable retail display in accordance with the invention. The display comprises a surface 20, or a table 10 having a top 20. Although in FIGS. 2, 4, and 9 the surface 20 or top 20 is shown as an ellipse, it is contemplated that the surface 20 or top 20 can be of any geometric shape, including but not limited to a circle, square, rectangle, etc. Furthermore, it is also contemplated that the surface 20 or top 20 can be made of any suitable material, such as wood, metal or plastic.

The display can be comprised of a table 10 or any other surface 20, and need not have support members 11 like the table 10 shown in the figures. Alternatively, the table 10 can have at least one support member 11 that can be configured in any manner that is sufficient to support the table 10. For example the table 10 can further have stationary legs 11 or wheels for mobility. A non-limiting example of a table 10 having support members 11 is shown in FIGS. 1 and 3-5.

As shown in FIGS. 1-4 and 9, the surface 20 or top 20 of the table 10 further comprises at least two elevations 12, 14. In a non-limiting embodiment shown, the table is divided among four substantially equal quadrants 22, 24, 26, 28. A first quadrant 22 and second quadrant 24 diagonally oppose one another and have an approximately equal first elevation 12. A third quadrant 26 and fourth quadrant 28 diagonally oppose one another and have an approximately equal second elevation 14. The different elevations 12, 14 of the top 20 allow a more aesthetically pleasing and alluring display of various merchandising display holders 40 held on posts 30 to attract consumers to the display surface 20 or table 10, compared to displays known in the prior art.

Each quadrant 22, 24, 26, 28 may be defined as a themed display zone. Themes for each quadrant may be defined by a common style, a type or category of jewelry, by a brand, or price range.

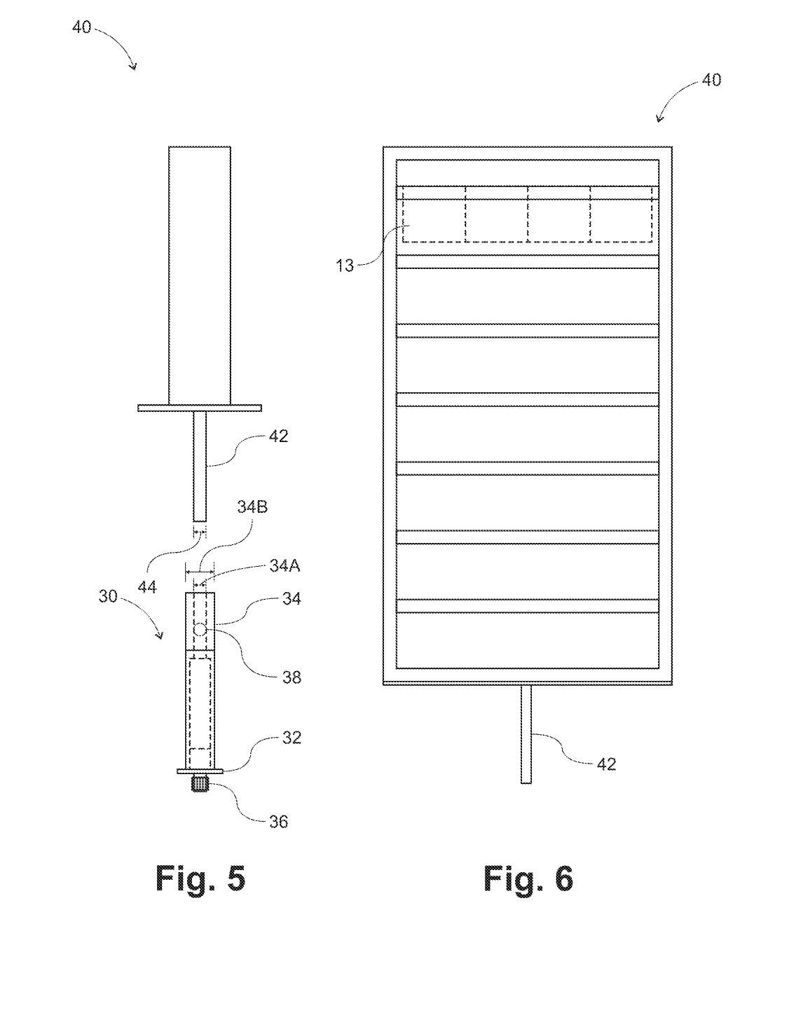

The surface 20 or top 20 of the table 10 includes at least one receptacle 16 therein to receive at least one post 30. The number and distribution of posts 30 on the surface 20 or top 20 can be varied. As shown in FIG. 5, each post has a first end 32 and a second end 34. The first end 32 of the post can attach with the surface 20 or top 20 of the table 10. The second end 34 of the post can attach with a merchandising display holder 40.

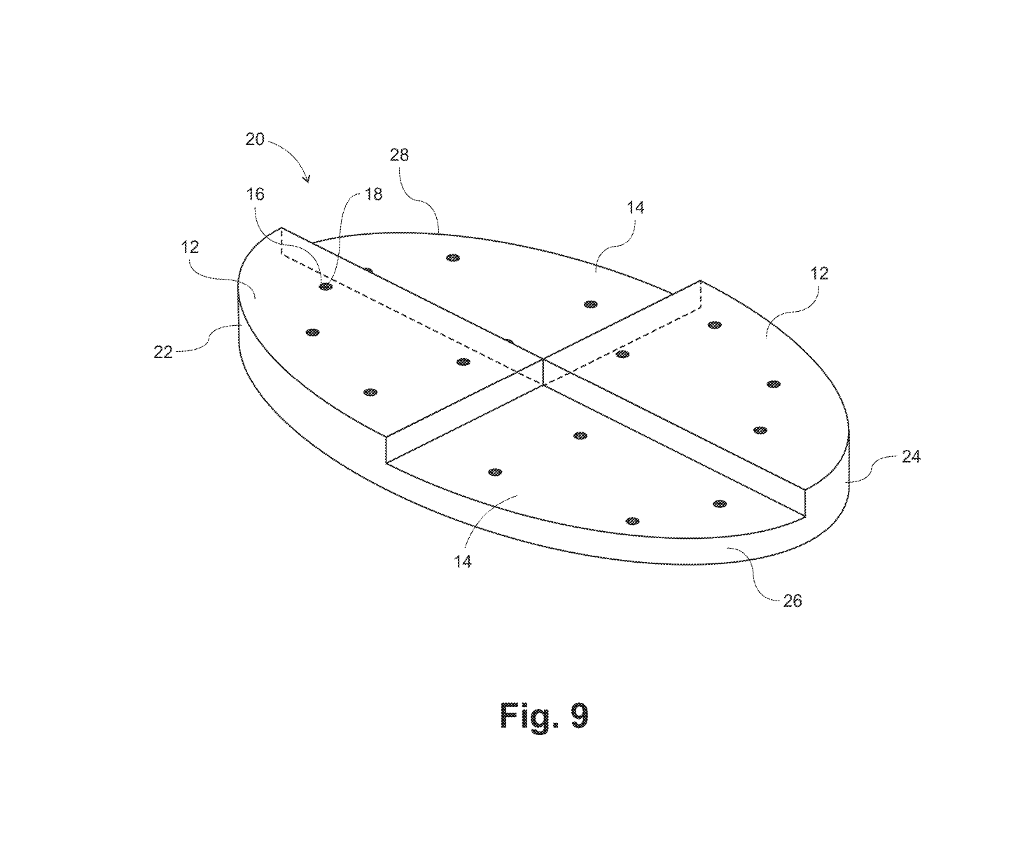

The posts 30 and receptacles 16 can be fitted with one another to allow secure attachment. As shown in FIGS. 5 and 9, a receptacle 16 can have a male threaded portion 18 to receive a first end 32 of a post 30 having a female threaded portion 36, or vice versa, such that the threaded portions 18, 36 engage one another to further hold the post 30 in a stable manner. The first end 32 of the post 30 can be removably attached to the post 30 in certain embodiments. For example, as shown in FIG. 5, the first end 32 of the post 30 can be a fitted insert. The receptacles 16 are capable of securely engaging the first ends 32 of the posts 30 to prevent movement of the post 30 during normal use and thus enable the invention to work for its intended purpose.

The post 30 is mounted to the top 20 by inserting post 30 into the receptacle 16, such that the body of the post 30 rests on the top 20 surface of table 10 as shown in FIG. 1. The posts 30 are interchangeable among the plurality of receptacles 16. In another embodiment, the post 30 can be secured to the surface 20 or top 20 by any appropriate mounting system, such as a washer and nut assembly that mounts the post 30 from the underside of the surface 20 or top 20 to maintain the post 30 in a stable upright position.

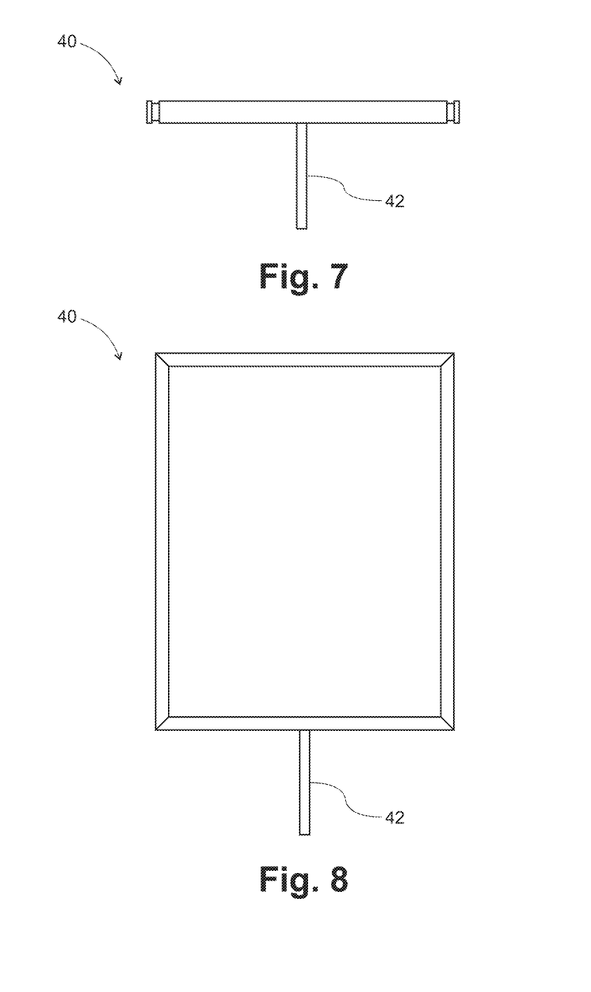

The post 30 can have a second end 34 that is capable of receiving a merchandising display holder 40 to which an item, such as a piece of jewelry, is placed for display. As shown in FIG. 1, the posts 30 can be of varying lengths, i.e. height, to display multiple types items on different posts 30 in a clear, attractive and organized manner. The merchandising display holder 40 can be of any various shape, size or configuration to display any item desired to be on display. For example, the merchandising display holder 40 can be a vertical rod that can be used to display bracelets or watches, as shown in FIG. 5. The merchandising display holder 40 can be a rack that can be used to display, e.g., earrings or cards 13 with earrings attached, as shown in FIG. 6. The merchandising display holder 40 can be a horizontal rod that can be used to display, e.g., bracelets, watches or necklaces, as shown in FIG. 7. As shown in FIG. 8, the merchandising display holder 40 can be a placeholder, in which a sign can be inserted.

The merchandising display holders 40 are interchangeable among the posts 30, thereby allowing different display arrangements. It is in the scope of the invention to have the posts and merchandising display holders made of any suitable material sufficient to maintain and hold the items chosen for display, for example, metal or stainless steel.

Regardless of its shape, size or configuration, the merchandising display holder 40 can have a connecting end 42 to attach to a second end 34 of a post 30 in any suitable manner. The second end 34 of the post 30 can have an inner diameter 34A and an outer diameter 34B. As shown in FIG. 5, the diameter 44 of the connecting end 42 can be substantially the same diameter as the inner diameter 34A that defines an aperture within the post 30 such that the merchandising display holder 40 is securely fitted in the post 30 when inserted in the post 30. The remaining portion of the post 30 beyond the aperture defined by the inner diameter 34A of the second end 34 of the post 30 can be solid.

In addition, the post 30 can have a locking member 38 to securely attach the merchandising display holder 40 to the post 30. The locking member 38 can be, for example, a screw or wing nut that is accommodated through a hole in the post 30 to engage a connecting end 42 of a merchandising display holder 40, so as to lock the merchandising display holder 40 into a desired position. Referring to FIG. 5, locking member 38 can be assembled to a post 30 by inserting a threaded portion of locking member 38 through a threaded hole provided in the post 30 to engage the merchandising display holder 40. The merchandising display holders 40 can be locked into the posts 30 at various lengths.

It is also within the scope of the invention that each post 30 and merchandising display holder 40 are permanently integrated as one assembly, having one end that can attach to the surface 20 or top 20 of the display 10 (the first end 32 of the post 30) and the other end is comprised of a merchandising display holder 40 that can hold items for display. When the post 30 and merchandising display holder 40 are integrated as one assembly, the assembly, like the posts 30, can be interchangeable among the receptacles 16 or attached in different positions on the different elevations 22, 24, 26, 28 of the display 10.

As such, it is contemplated a myriad of displays can be achieved by combining posts 30 in different locations on the surface 20 or top 20 of a table 10, with various heights and assortments of merchandising display holders 40, to create a multitude of arrangements and configurations.

This invention is not to be limited by the embodiments shown in the drawings and described in the specification, which is given by way of example and not of limitation, but only in accordance with the scope of the appended claims. All equivalent adaptations and modifications based on the technological spirit of the present invention shall remain protected within the scope and claims of the invention herein.

What is claimed is:

1. A display comprising:
a table having a top where said top has four approximately equal quadrants;
a first and second quadrant of said four quadrants have an approximately equal first elevation and said first and second quadrants diagonally oppose each other;
a third and fourth quadrant of said four quadrants have an approximately equal second elevation different from said first elevation and said third and fourth quadrants diagonally oppose each other;
each of said quadrants having a plurality of receptacles formed therein for receiving a plurality of posts; each of said posts having a first end and a second end; said first end adapted for stable insertion into at least one of said receptacles and said second end adapted for receiving a merchandising display holder; said posts adapted to be interchangeable among said receptacles; and
whereby items may be displayed having different themes for each quadrant.

2. The display of claim 1, said top of said table is elliptical.

3. The display of claim 1, said plurality of posts having more than one length among them.

4. The display of claim 1, said merchandising display holder is selected from a group comprising a bracelet, necklace, ring, watch and a sign holder.

5. The display of claim 1, wherein each of said plurality of receptacles has a male threaded portion and each said first end of each of said posts has a female threaded portion, said male and female threaded portions are capable of engaging one another.

6. The display of claim 1, each of said posts having a locking member capable of locking each of said merchandising display holder when received such that each said merchandising display holder is capable of being securely attached to each said post.

7. The display of claim 1, said second end of each said post having an inner diameter and an outer diameter wherein said inner diameter is smaller than said outer diameter;
said merchandising display holder having a connecting end;
whereby said connecting end of said merchandising display holder fits within said inner diameter of said second end of each said post.

8. A display comprising:
a surface having at least two elevations; at least one post to each elevation, each of said posts having a first end and a second end;
said first end capable of securely attaching to said surface and said second end comprising a merchandising display holder; and,
whereby a variety of items may be displayed on each merchandising display holder.

9. A method for assembly of a display comprising the steps of:
mounting a plurality of posts into a plurality of receptacles on a display table having at least two elevations and more than one quadrant;
mounting a merchandising display holder on each of said posts;
wherein said plurality of posts and said plurality of merchandising display holders are capable of being combined in different arrangements and configurations on said at least two elevations of said display table to achieve more than one themed display zone corresponding to each quadrant.
